(19) United States
(12) Patent Application Publication
(10) Pub. No.: US 2013/0284015 A1
(43) Pub. Date: Oct. 31, 2013

(54) HANDS-FREE SINGLE OPERATOR VEHICLE FLUID LINE BLEEDER SYSTEM

(71) Applicant: Vincent Menten, East Setauket, NY (US)

(72) Inventor: Vincent Menten, East Setauket, NY (US)

(21) Appl. No.: 13/456,186

(22) Filed: Apr. 25, 2012

(51) Int. Cl. F15B 15/20

(52) U.S. Cl. 92/145

(57) ABSTRACT

A hands-free fluid bleeding apparatus to use during a vehicle's servicing. It comprises a remotely controlled actuator having an elongated body, a first end provided with pedal engaging means, and a second end provided with anchoring means designed to anchor to a fixed location within the vehicle. It also comprises a hands-free, remote control means communicatingly connected to the remotely controlled actuator. The hands-free remote control means allows a single user to activate the actuator, and apply suitably-directed, remotely-controlled pulsed force upon the pedal of the vehicle, while simultaneously bleeding the vehicle's fluid lines connected to the pedal.

### BACKGROUND OF THE INVENTION

1. Field of Invention

This invention relates to service tools for hydraulic brake systems. More particularly, the present invention is directed to a single-user, hands-free, remotely controlled, length-adjustable elongated shaft having a pneumatic cylinder-and-piston therein, the shaft for contacting and pumping a vehicle brake pedal by remote pneumatic command wherein a user, with hands free for alternate activity, uses a foot-actuated remote control module to issue pneumatic commands to move the piston between a retracted position and an extended position.

2. Prior Art

All motor vehicles, i.e., cars, trucks, sports utility vehicles, mini-vans and so on, are provided with brake systems; more particularly with hydraulic brake systems.

Hydraulic brake systems comprise a master cylinder, a brake pedal, several brake cylinders, brake pipes or lines, and an incompressible fluid such as brake fluid. The master cylinder is connected to the several brake cylinders with the brake pipes or lines that are filled with the brake fluid. When the operator of the motor vehicle applies a downward force on the brake pedal, as with for example by pressing his or her foot downward on the brake pedal while driving, the downward force applied on the brake pedal is transferred via the brake fluid in the master cylinder through the brake lines to the several brake cylinders, to apply sufficient pressure and force on the wheels and eventually stop the motor vehicle. If the force applied on the brake pedal is not properly transmitted through the brake fluid to the brake cylinders, then the hydraulic brake system will not function and the car will not stop.

In order for the downward force applied on the brake pedal to be properly transmitted through the brake fluid to the brake cylinders, hydraulic brake systems need to be kept in peak operating condition by being maintained properly. Arguably, hydraulic brake system maintenance is one of the most important processes in motor vehicle maintenance.

During hydraulic brake system maintenance, air can enter the system in any number of ways. For example air can be vacuumed into the system through a point in the system where a leak has developed. Another way that air can enter the system is when the brake fluid in the reservoir in the master cylinder drops below certain optimum level as for example if there is a slow leak in the system. Yet another way that air can enter the system is when the hydraulic system undergoes repairs which necessitate the replacement of parts or via the use of improper brake bleeding techniques.

The presence of air in the hydraulic brake system significantly reduces the effectiveness of the system because it significantly affects the force that is ultimately applied on the brake cylinders. Unlike the incompressible brake fluid in the system, air is extremely compressible. Thus, when the motor vehicle operator compresses the brake pedal, some of the force applied is wasted compressing the air that might have leaked into the system, instead of being transferred to the brake fluid, thereby decreasing the ultimate force that reaches the brake cylinders. When the hydraulic force drops, the overall breaking power correspondingly decreases as well and the brake pedal feels “mushy” or “spongy” to the user. Thus, it is absolutely necessary to purge the air, which is usually in the form of air bubbles, out of the hydraulic brake system, if the system is to operate at peak efficiency, without a drop in the hydraulic force to the brake cylinders.

The process by which the brake lines, i.e., the pipes and hoses, containing the brake fluid are purged of any and all air bubbles is called brake bleeding.

Generally speaking, there are four (4) main methods of brake bleeding: Pump and Hold; Vacuum; Pressure; and Reversed Pressure. Pump and Hold generally requires two people. The other methods can be done by a single person. The present invention relates to the Pump and Hold Method of brake bleeding which generally requires two people.

The Pump and Hold method comprises the following steps: (a) engaging two individuals, one to sit inside the vehicle and pump the brake pedal, and one to operate the bleeder valve at each of the brake cylinders at each of the wheels of the motor vehicle respectively; (b) having the first person pump the brake pedal to compress the air and then holding the pressure on it: c) while the first person is holding the pressure on the brake pedal, having the second person open the bleeder valve to let out fluid and air and thereafter closing the valve after the pedal has landed (to prevent air from being sucked back in through the valve on the upstroke of the brake pedal); d) repeating the process many times for each wheel; (e) providing each bleeder valve with a length of clear tubing and running same to a container such that the toxic brake fluid is contained during the bleeding process and monitored for air bubbles; and f) replenishing the master reservoir frequently.

Prior art has been developed for the purpose of optimizing the two person pump and hold method by reducing it to a single person pump and hold process.

For example, U.S. Pat. No. 7,152,636 discloses a brake flush accelerator (BFA) which selectively depresses a brake pedal while the master cylinder reservoir is under pressure from a brake flush machine, forcing fluid through the system at a very rapid rate. The BFA also provides a thorough flush as internal hydraulic pressure from the master cylinder can be used to exert force to remove contaminates from the brake system. The BFA exposes the low/no pressure area of the master cylinder to fluid flow from the pressurized master cylinder. When the brake pedal is depressed, a port in the master cylinder is opened which exposes the low/no pressure area of the master cylinder to fluid flow from the pressurized master cylinder reservoir. The BFA receives its pneumatic power from an air compressor or is easily adapted to a car tire. The BFA can be powered directly from the brake flush machine or attached to a vehicle's battery.

Likewise, U.S. Patent Application Publication No. 2001/0047915 discloses a brake fluid bleeding apparatus provided with an air cylinder portion which is expandable and contractable, a pedal attachment portion disposed on an end of the air cylinder portion and detachably attached to a brake pedal of an automobile, and a contact piece portion disposed on another end side of the air cylinder portion and contact a fixation portion inside the automobile to position and fix the air cylinder portion. Further, the brake fluid bleeding apparatus is provided with a flexible air pipe portion one of which end portions is connected to an air supplying hole of the air cylinder portion and the other has an open-close valve, and a connecting portion disposed on the other end side of the air pipe portion for connection to an air supplier.

Similarly, U.S. Pat. No. 6,131,712 discloses a brake pedal actuator having a tubular member and a stem telescopically mounted in the tubular member. A J-shaped hook is mounted on the stem for attachment to a segment of a steering wheel of a vehicle. A pedal clamping mechanism is mounted on the tubular member for attachment to the brake pedal of the vehicle. A handle is mounted on the tubular member for allowing a manual pushing and pulling of the brake pedal by a user standing outside the vehicle. In another aspect of the invention, the actuator has a wedge-type locking sleeve and nut affixed to the clamping mechanism for selectively locking the mechanism and for preventing a loosening or clapping of the latching mechanism when the brake pedal is manually actuated back and forth. In a further aspect of the present invention, the brake pedal actuator comprises a ring which is movably mounted on the stem and restrictively positional along the stem. When the brake pedal actuator is in use in a still mode, the position of the ring and the end of the tubular member are usable for monitoring a creeping movement of a brake pedal under a load from the actuator.

Yet another example of prior art, which has been developed for the purpose of optimizing the two person pump and hold method by reducing it to a single person pump and hold process, is U.S. Pat. No. 5,299,668. It discloses a remotely controlled actuator for depressing a brake pedal so as to permit the brake system to be bled by a single operator. There is a pneumatic cylinder having attachment fittings mounted to its ends, and these engage the brake pedal and the rim of the steering wheel. Compressed air is supplied to the pneumatic cylinder by way of a portable control valve, so that as the pneumatic cylinder extends, one attachment fitting depresses the brake pedal while the other reacts against the steering wheel. The portable control valve is connected to the cylinder by long, flexible air hoses, so as to permit the operator to move from wheel cylinder to wheel cylinder. A pressure regulator allows the operator to adjust the pressure which is exerted on the brake pedal.

Likewise, Canada Patent Application No. 2,260,628 discloses an apparatus for bleeding the brakes of a vehicle using a hydraulic braking system activated by a brake pedal, which comprises a brake pedal manipulating unit installable in the vehicle to engage with the brake pedal, and a remote control switch for activating the unit to press and release the brake pedal as desired by the user to provide hydraulic pressure to bleed the brakes. The brake pedal manipulating unit is installable between the brake pedal and the steering wheel. The apparatus allows a single person to bleed the brakes while still relying on the brake pedal to provide the pressure necessary to purge contaminated brake fluid from the system.

While each and every one of the devices set forth herein above, and many others not disclosed herein, aspire to optimize the two-person pump and hold method by reducing it to a single person pump and hold method, none of the devices set forth herein above have the inherent ability to allow for the bleeding of the brake valves concomitantly with the hands-free pressing of the brake pedal. Instead, each and every one of the devices herein above discloses a single person sequential, two-step process for bleeding the brakes comprising: i) manually, i.e., by hand, activating the switch to actuate the device and depress the brake pedal; and thereafter (ii) bleeding the brakes. This means that the operator's attention and hands have to engage in two sequential attention demanding actions: a) using his hands to activate the switch which activates the device to depress the brake pedal; and b) thereafter turning his attention and removing his hands from the device activating switch, and directing his attention to and placing his hands on the brake bleeding valve and the fluid that is discharged therefrom. This can become quite burdensome and tedious and even aggravating, particularly if the manual switch to activate the devices has not been properly secured in close proximity to the operator or if the device bearing the manual switch is misplaced and cannot be found in the clutter usually found in and around the vehicle maintenance location. Further, the manipulation of the switch by hand to actuate the device and press the pedal does not mimic or simulate that brake pedal pumping of the second operator of a two person pump and hold method.

Accordingly, there is a need for improvement in the prior art devices to allow for the bleeding of the brake valves concomitantly with the hands-free pressing of the brake pedal, i.e., concomitant or simultaneous single person hand-bleeding of the brake valves and hands-free pressing of the brake pedal. This way the operator's attention and hands are focused strictly on the brake bleeding valve and the brake fluid that is discharged for purposes of insuring that there are no air bubbles left within the hydraulic brake system while the operator's aggravation is greatly reduced.

### SUMMARY OF THE INVENTION

Accordingly, it is an object of the present invention to provide a brake bleeding apparatus and system that possesses the inherent ability to allow for a single person bleeding of the brake valves concomitantly and simultaneously with the hands-free pressing of the brake pedal.

It is a further object of the present invention to provide a brake bleeding apparatus and system that provides a single person concomitant and simultaneously occurring two-step process for bleeding the brakes.

It is still another object of the present invention to provide a brake bleeding apparatus and system that comprises the non-manual activation of a switch to actuate the apparatus and depress the brake pedal.

It is yet another object of the present invention to provide a brake bleeding apparatus and system that allows for the easy access and activation of the switch to activate the device and depress the brake pedal and to provide for an experience that mimics or closely simulates the experience and feel of the brake pedal pumping of the two person pump and hold method.

The present invention comprises a remotely controlled actuator, said actuator comprising an elongated shaft, said elongated shaft having means for moving between a first extended position and a second retracted position, said elongated shaft having a first end for contacting a vehicle brake pedal and a second end for statically contacting a fixed portion of the vehicle, said elongated shaft having hands-free remote control means for allowing a single user to apply suitably-directed, remotely-controlled pulsed force upon the brake pedal of a vehicle so as to pump vehicle brake lines during the process of bleeding the brakes.

These and other objects, advantages, features, and characteristics of the invention will be apparent from the following description of a preferred embodiment, considered along with the accompanying drawings.

### BRIEF DESCRIPTION OF THE DRAWINGS

It is believed that the present invention will be better understood from the following detailed description taken in conjunction with the accompanying drawings, in which the numerals represent identical elements and wherein:

FIG. 1 is a top plan view showing a first embodiment of the hands-free brake bleeding apparatus and system relating to the present invention.

FIG. 2 is a top plan view showing a second embodiment of the hands-free brake bleeding apparatus and system relating to the present invention.

LIST OF ELEMENTS AND THEIR RESPECTIVE
IDENTIFYING NUMERALS

| | |
|---|---|
| 10 | The inventive hands-free brake bleeding apparatus |
| 20 | remotely controlled actuator |
| 30 | elongated body |
| 40 | first end of actuator |
| 42 | brake pedal engaging means |
| 50 | second end of actuator |
| 52 | anchoring means |
| 54 | steering wheel mounting fixture |
| 54a | steering wheel adjustment screw |
| 54b | steering wheel adjustment screw pad |
| 60 | pneumatic cylinder |
| 62 | air port |
| 64 | cylinder-enclosed chamber |
| 66 | piston |
| 68 | piston rod |
| 70 | means for contacting vehicle pedal |
| 80 | hands-free remote control means |
| 82 | foot actuated pedal electrical switch |
| 82a | signal transmitter |
| 84 | electric/pneumatic solenoid valve |
| 84a | signal receiver |
| 86 | communicating means |
| 88 | user-controllable air pressure regulator valve |
| 90 | source of compressed air |
| 94 | compressed air tubing |

### DETAILED DESCRIPTION OF THE PREFERRED EMBODIMENT

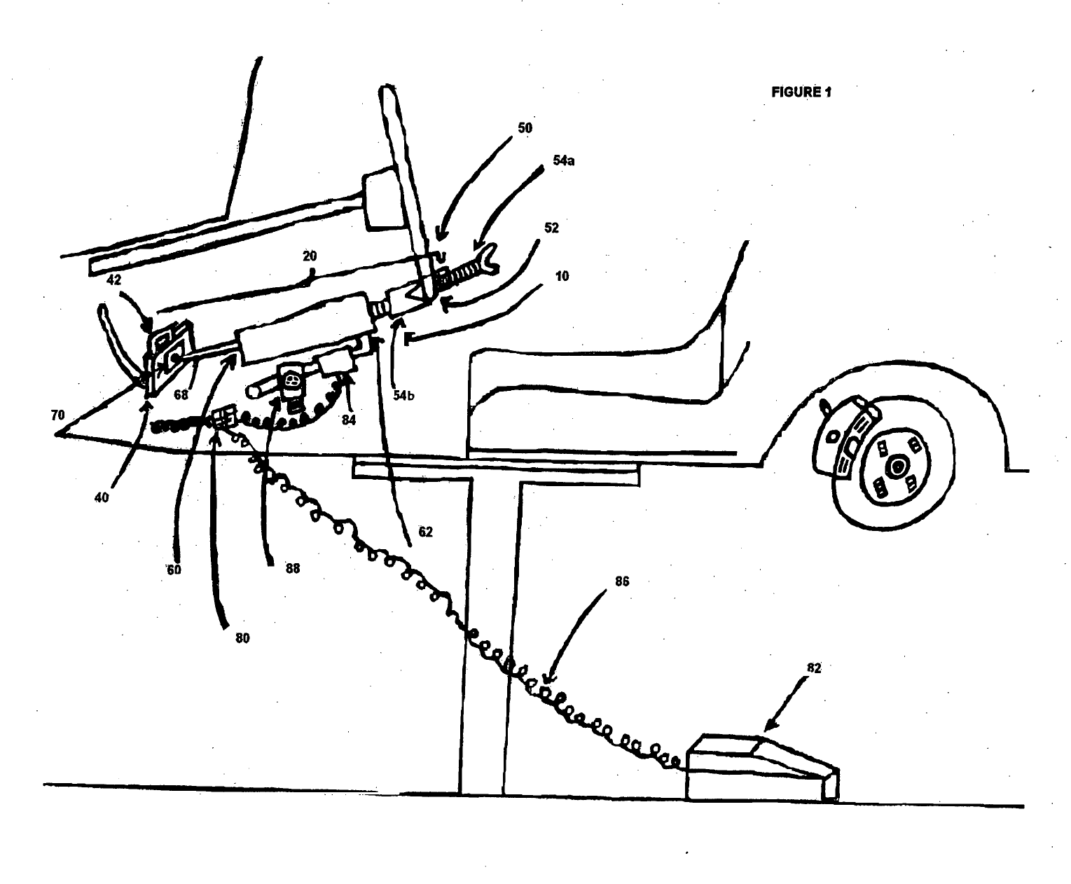

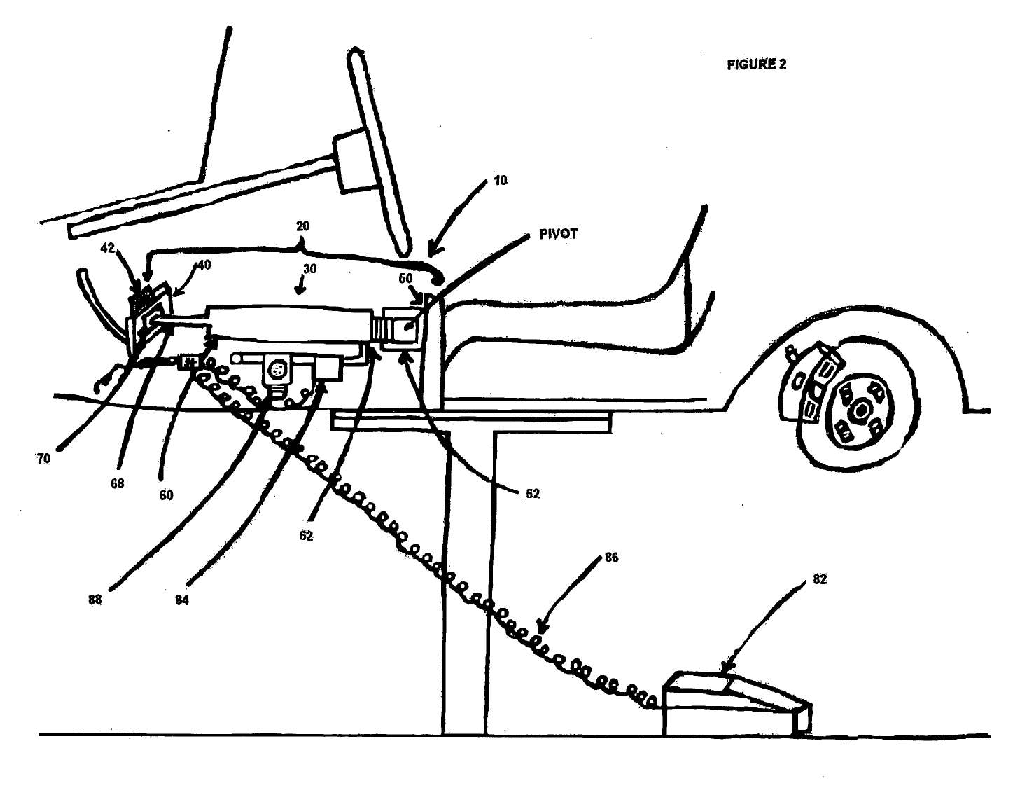

Referring more specifically to FIGS. 1 and 2, each one generally depicts the hands-free brake bleeding apparatus and system for use in connection with the hydraulic brake system of a vehicle, in accordance with the present invention at 10.

The hands-free brake bleeding apparatus 10 comprises a remotely controlled actuator 20 having an elongated body 30, a first end 40 and a second end 50. Said first end 40 is provided with brake pedal engaging means 42 and the second end 50 is provided with an anchoring means 52 designed to anchor on the steering wheel, on the driver's seat or any other fixed point within the vehicle. Thus, for example, when the hands-free brake bleeding apparatus 10 is installed as shown in FIGS. 1 and 2, the brake pedal engaging means 42 engages the brake pedal of the vehicle, and the anchoring means 52 engages the seat of the vehicle, or a lower portion of the rim of the wheel of the vehicle, respectively, so that the actuator assembly 10 is fixedly positioned between the brake pedal and the seat or steering wheel, respectively.

The hands-free brake bleeding apparatus 10 is further provided with hands-free, remote control means communicatingly connected to said actuator, for allowing a single user to activate the actuator 20, for purposes of applying suitably-directed, remotely-controlled pulsed force upon the brake pedal of a vehicle so as to pump for example the vehicle brake lines during the process of bleeding the brakes.

The elongated body 30 comprises a pneumatic cylinder 60 provided with an air port 62 that can function both as an inlet and alternately as an outlet for compressed air. Alternatively, the pneumatic cylinder 60 could be provided with two air ports 62, one port to function as an inlet for compressed air and one port to act as an outlet of compressed air. The pneumatic cylinder 60 further comprises a cylinder-enclosed chamber 64, a piston 66 concentrically disposed within said cylinder-enclosed chamber 64, and a piston rod 68 coaxially and fixedly connected to said piston 66 and having such length that it extends and telescopes outwardly and beyond the lower, outer walls of the cylinder-enclosed chamber to form a support shaft for said brake engaging means 42 at the first end 40. When compressed air is introduced into the cylinder-enclosed chamber 64 of the pneumatic cylinder 60 via the inlet port 62, it exerts a force on the piston 66. Such force displaces or moves the piston 66 along the length of the cylinder-enclosed chamber 64 of the pneumatic cylinder 60 towards the first end 40 of the actuator 20, such that the piston rod 68 is able to move between a first retracted position to a second extended position, thereby applying pressure on and pushing or pumping the brake downwardly towards the floor of the vehicle. When the compressed air is released, the brake pedal acts as a spring to push the piston rod 68 and force the piston 66 to move from said second extended position back to its first retracted position within the cylinder-enclosed chamber 64 of the pneumatic cylinder 60.

The piston rod 68 may optionally comprise a jack screw, which may be optionally attached to a reversible direction electric motor equipped with a motor shaft having at least one suitable gear mounted thereon. The motor gear is in geared contact with the threading of the jack screw. Thus, the length of the hands-free brake bleeding apparatus can be adjusted to accommodate various model automobiles, by having the jack screw shortened or lengthened by geared urging from said effective geared contact with reversible electric motor between a first jack screw extended position and a second jack screw retracted position.

The pneumatic cylinder 60 further comprises means for fixedly engaging to the steering wheel or pivotally supporting said seat anchoring means 52. Such means are located at the end of said pneumatic cylinder 60, which is opposite its piston-rod-bearing end.

One embodiment of the anchoring means 52 comprises steering wheel mounting fixture 54 having a steering wheel adjustment screw 54a and a steering wheel adjustment screw pad 54b. Optionally, the steering wheel mounting fixture 54 can be a Y-shaped steering wheel hook for user-attachable and detachable grasping of the steering wheel of the vehicle in at least two locations, which are suitable for accepting the static reactive forces developed when said piston rod 68 moves between said first retracted position and said second extended position in extended mechanical contact with a vehicle brake pedal. As a result of such locations, the Y-shaped hook spreads said static reactive force over an arc portion of said vehicle steering wheel and prevents damage to said steering wheel.

An alternative embodiment of the anchoring means 52 comprises a padded substantially flat member for contacting a fixed driver's seat. Thus, it is the driver seat instead of the steering wheel which accepts the static reactive force developed when the piston rod 68 moves between the first retracted position and the second extended position to allow the piston rod 68 to exert pressure and force down the vehicle brake pedal.

Compressed air is introduced into the pneumatic cylinder 60 of the actuator 20 with a hands-free, remote control means 80. Such means comprises a foot-actuated pedal electrical switch 82, an electric/pneumatic solenoid valve 84, and means 86 for communicatingly connecting said foot-actuated pedal electrical switch 82 to said electric/pneumatic solenoid valve 84, such means comprising wiring or wireless means of communication; a user-controllable air pressure regulator valve 88, a source of suitably-pressured compressed air 90 and means for communicatingly interconnecting said source of compressed air 90, said user controllable air pressure regulator valve 88 and said electric/pneumatic solenoid valve 84, i.e., tubing 92, with the air port 62 of the pneumatic cylinder 60 of the actuator 20. Thus, when during the bleeding process, a single user depresses the foot-actuated pedal electrical switch 82 with his foot, while simultaneously focusing his hands and his attention on the bleeder valve of the brakes, the foot-actuated pedal electrical switch 82 communicates with and activates the electric/pneumatic solenoid valve 84, through communicating means 86 to release compressed air of suitable pressure, from the compressed air source 90, regulated by said air pressure regulator valve 88, and conduct via said tubing 92 said compressed air into said air port 62 of said pneumatic cylinder 60. Such controllably released compressed air, in turn, urges said piston rod 68 from said first retracted position to said second extended position, to apply a suitable vehicle brake pedal pumping force to said vehicle brake pedal, as a result of the contact between said vehicle brake pedal and said extended piston rod 68, through the brake pedal engaging means 42.

If the means 86 for communicatingly connecting the foot-actuated pedal electrical switch 82 to the electric/pneumatic solenoid valve 84 is wireless, then the foot actuated pedal electrical switch 82 comprises a transmitter 82a and the electric/pneumatic solenoid valve 84 comprises a receiver 84a. Thus when the single user depresses the foot-actuated pedal electrical switch 82 with his foot, while simultaneously focusing his hands and his attention on the bleeder valve of the brakes, the foot-actuated pedal electrical switch 82 generates and sends a wireless signal through its transmitter 82a to the receiver 84a of the electric/pneumatic solenoid valve 84. Such signal activates the electric/pneumatic solenoid valve 84 to release compressed air from the compressed air source 90. In the preferred embodiment the transmitter 82a and receiver 84a are of the kind suitable to generate and receive a signal having a wavelength selected from a group of wavelengths that make up and span the Radio Frequency wavelength spectrum.

Thus, there is no question that the inventive hands-free brake bleeding apparatus 10 described herein above, accomplishes all of its objectives and achieves the goal of providing a brake bleeding apparatus and system that: a) possesses the inherent ability to allow for the bleeding of the brake valves concomitantly with the hands-free pressing of the brake pedal of a vehicle; b) provides a single person, a concomitant two-step process for bleeding the brakes; c) comprises the non-manual, single person activation of a switch to depress the brake pedal; d) allows for the easy access and activation of the switch to activate the device and depress the brake pedal; and e) provide for an experience that mimics or closely simulates the experience and feel of the brake pedal pumping of the two person pump and hold method. Further, not only does it allow for the diagnosing and servicing of air brakes, but it also allows for the diagnosing and servicing of brake lights, and the braking and diagnosing of the braking capacity of each wheel. Finally, it also allows for the diagnosis and service of hydraulic clutches, since the device can be connected and used to actuate a clutch pedal.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, I claim:

1. A hands-free fluid bleeding apparatus for use during a vehicle's servicing comprising:
a. a remotely controlled actuator having
i. an elongated body,
ii. a first end provided with pedal engaging means,
iii. a second end provided with anchoring means designed to anchor to a fixed location within the vehicle; and
b. a hands-free, remote control means communicatingly connected to said actuator, for allowing a single user to activate said actuator, for purposes of applying suitably-directed, remotely-controlled pulsed force upon a pedal of the vehicle, while simultaneously bleeding the vehicle's fluid lines connected to said pedal.
